(19) United States
(12) Patent Application Publication
(10) Pub. No.: US 2024/0299143 A1
(43) Pub. Date: Sep. 12, 2024

(54) 3D PRINTED DENTURE

(71) Applicant: James R. Glidewell Dental Ceramics, Inc., Newport Beach, CA (US)

(72) Inventor: Maggie Xiaoxia Liu, Lake Forest, CA (US)

(73) Assignee: James R. Glidewell Dental Ceramics, Inc., Newport Beach, CA (US)

(21) Appl. No.: 18/118,981

(22) Filed: Mar. 8, 2023

(51) Int. Cl. A61C 13/00; A61C 13/08; A61C 13/083; B33Y 70/00; B33Y 80/00; C08K 3/40; C08K 9/02

(52) U.S. Cl. CPC A61C 13/0019; A61C 13/082; A61C 13/083; B33Y 70/00; B33Y 80/00; C08K 3/40; C08K 9/02

(57) ABSTRACT

A method for making an intraoral device that includes mixing at least one oligomer, at least one monomer, at least one crosslinker, at least one silanized glass filler, and at least one photoinitiator resulting in a mixture; forming the resulting mixture into an intraoral device shape using a three-dimensional printing method; and light curing the mixture using the three-dimensional printing method to obtain the intraoral device.

### BACKGROUND

In the United States, the population of 65-year-olds and older is increasing in number as the average life expectancy increases. The importance of stain and wear resistant denture becomes clear when considering the number of patients who will need prosthodontic treatment. One major shortcoming of dentures (base with acrylic denture teeth) is their gradual color change over time. Clinically, the staining pattern shows most likely at the base/teeth, tooth/tooth connected margin area and rough surface of base and/or teeth. Color changing of acrylic resins may be due to internal or external factors. Internal or intrinsic factors are mainly related to chemical changes in the composition and formulation of materials while external factors mainly depend on the surface properties of the material and the environment in which the material is placed. It is well known that some beverages such as tea, coffee and fruit juice leave stains on dental material. The magnitude of color change also depends on the oral hygiene status and frequency of cleaning by patients.

Manufacturers have been striving to improve the stain resistance and mechanical properties of denture teeth for decades. Dentsply introduced denture teeth to reduce the potential for discolorations and delamination between layers caused by tooth wear or laboratory alterations in the 1970s, the material reported was made of polymethacrylate, or PMMA, with an inter-penetrating polymer network (IPN) and a double cross-linked material layering. Ivoclar Vivadent introduced denture teeth made of a synthetic polymer based on PMMA with a double cross-linked polymer and matrix, which reported is solvent resistant and provides shade stability and resistance to mechanical wear. CAD-CAM technology with advanced 5-axis milling has been used to fabricate denture bases from prepolymerized acrylic resin blocks that are less porous than conventional denture acrylic resin. A complete denture fabricated entirely by a milling process where monolithic teeth are milled as part of the denture base has been introduced. The studies show the stainability of milled acrylic resins was no better than that of conventional materials. However, CAD-CAM milled denture blocks with teeth and base acrylic resins had better resistance to stain accumulation at the tooth-denture base interface than those of conventional processing methods.

Additively manufactured denture resins demonstrated the maximum color change compared to conventional heat-polymerized and CAD/CAM subtractively manufactured denture resins. The stain resistance of three-dimensional-printed (3DP) denture base and teeth product has not been reported.

### SUMMARY

Disclosed herein is a method for making an intraoral device comprising:
mixing at least one oligomer, at least one monomer, at least one crosslinker, at least one silanized glass filler, and at least one photoinitiator resulting in a mixture; and
polymerizing the resulting mixture in a mold to form the intraoral device.

Also disclosed is a method for making an intraoral device comprising:
mixing at least one oligomer, at least one monomer, at least one crosslinker, at least one silanized glass filler, and at least one photoinitiator resulting in a mixture;
forming the resulting mixture into an intraoral device shape using a three-dimensional printing method; and
light curing the mixture using the three-dimensional printing method to obtain the intraoral device.

Further disclosed is an intraoral device comprising a composite material that comprises:
a polymeric matrix made from polymerizing at least one oligomer, at least one monomer, at least one crosslinker, and at least one photoinitiator; and
at least one silanized glass filler.

Additionally disclosed is a polymerizable composition comprising at least one oligomer, at least one monomer, at least one crosslinker, at least one silanized glass filler, and at least one photoinitiator.

The foregoing will become more apparent from the following detailed description, which proceeds with reference to the accompanying figures.

### BRIEF DESCRIPTION OF THE DRAWINGS

FIG. 1 is a graph showing AE (L*a*b* measurement) for commercial PMMA denture, commercial 3D printed (3DP) denture competitors and the presently disclosed 3DP denture in the periods of 1 week to 4 weeks soaked in black coffee.

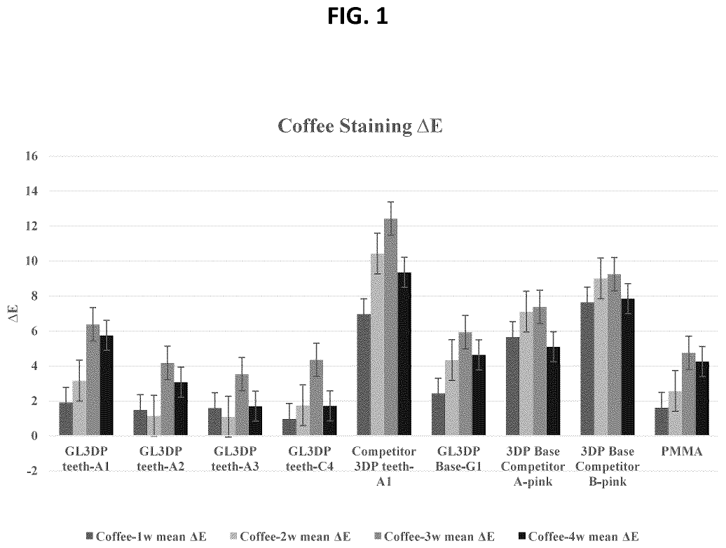

FIG. 2 is a graph showing AE (L*a*b* measurement) for commercial PMMA denture, commercial 3DP denture competitors and the presently disclosed 3DP denture in the periods of 1 week to 4 weeks soaked in grape juice.

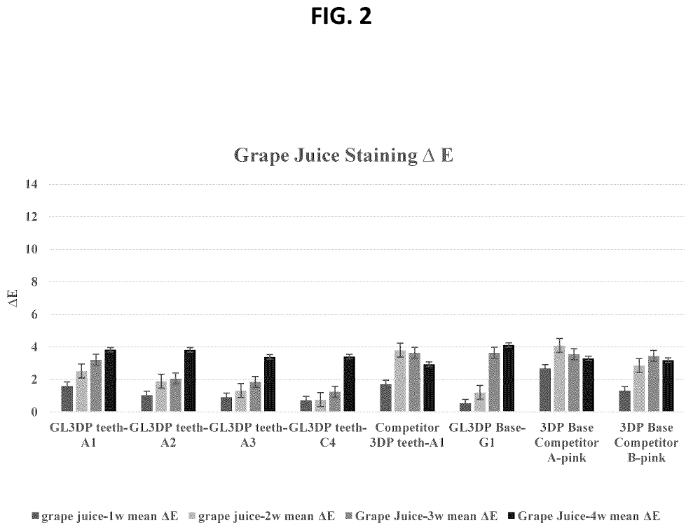

FIG. 3 is a graph showing AE (L*a*b* measurement) for the presently disclosed 3DP denture with or without applying sealant on the base-teeth interface area for up to 20 days soaked in black coffee without cleaning.

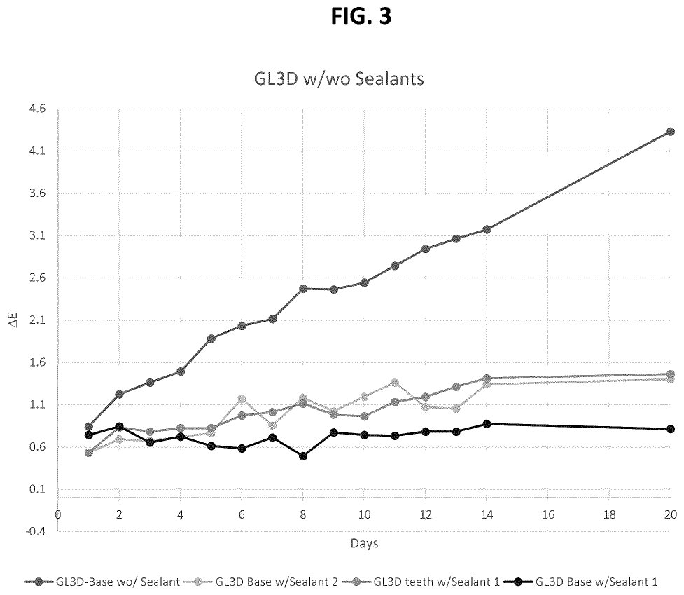

FIG. 4 is a graph showing antimicrobial activities-in vitro (24 hours)

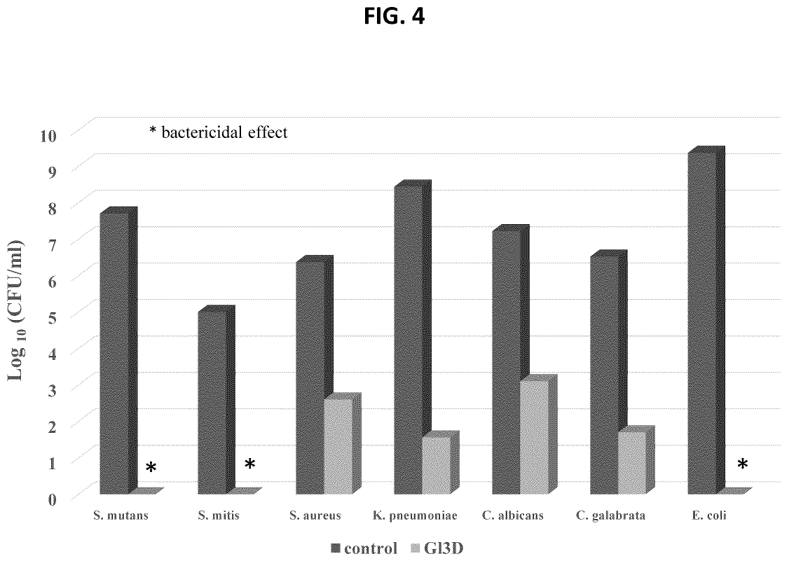

### DETAILED DESCRIPTION

### Terminology

The following explanations of terms and methods are provided to better describe the present compounds, compositions and methods, and to guide those of ordinary skill in the art in the practice of the present disclosure. It is also to be understood that the terminology used in the disclosure is for the purpose of describing particular embodiments and examples only and is not intended to be limiting.

The term “antimicrobial” refers to an inhibiting effect on the growth and/or adhesion of bacteria and/or fungus according to the tests provided herein.

The term “oligomer” generally refers to a molecule composed of repeating structural units connected by covalent chemical bonds and characterized by a number of repeating units less than that of a polymer (e.g., equal to or less than 10 repeating units) and a lower molecular weight than polymers (e.g., less than 5,000 Da or 2,000 Da). In some cases, oligomers may be the polymerization product of one or more monomer precursors. In an embodiment, an oligomer cannot be considered a polymer in its own right.

The term “reactive diluent” generally refers to a substance which reduces the viscosity of another substance, such as a monomer or curable resin. A reactive diluent may become part of another substance, such as a polymer obtained by a polymerization process. In some examples, a reactive diluent is a curable monomer which, when mixed with a curable resin, reduces the viscosity of the resultant formulation and is incorporated into the polymer that results from polymerization of the formulation.

### Compositions and Methods of Use

Disclosed herein is a three-dimensional printable (3DP) polymeric composition that is suitable for forming appliances for oral applications, including intraoral devices having substrates that contact the gums or palate of a patient, such as the base of full or partial arch dentures, or dental splints, bridges, and the like. The composition provides improved stain resistance, antimicrobial properties and/or mechanical properties of 3DP dentures. The disclosed 3DP composition materials exhibited less pronounced color changes compared to other nano-filler or filler free 3DP denture resins when exposed to discoloration media (e.g., coffee and grape juice).

In certain embodiments, the composition is a photocurable composition that includes at least one monomer, at least one oligomer, at least one crosslinker, at least one photoinitiator, at least one glass filler, and at least one antimicrobial agent.

In certain embodiments, the composition includes more than one type of glass filler material, wherein each glass filler material has distinct particle sizes.

Also disclosed herein is a composite material that includes a photocured polymeric matrix resin that includes at least two types of silanized glass filler particles, wherein the silanized glass filler particles occupy voids within the matrix resin. In certain embodiments, the silanized of the glass filler particles prevents gaps that could form at the interface due to matrix resin swelling by water uptake. In certain embodiments, a first silanized glass filler has a particle size of 1 μm to 20 μm, more particularly 1 μm to 5 μm, and a second silanized glass filler has a particle size of 0.3 μm to 1 μm, more particularly 0.3 μm to 0.7 μm. In certain embodiments, a third silanized glass filler has a particle size of 0.05 μm to 0.3 μm, more particularly 0.1 μm to 0.2 μm. The particle size may be determined by scanning electron microscopy (SEM) and X-ray diffraction (XRD).

Also disclosed herein is a method that includes applying a sealant to a tooth-denture base interface to reduce the possibility of staining at the tooth-denture base interface area.

In certain embodiments, the monomer(s), oligomer(s) and crosslinker(s) are hydrophobic. Hydrophobic monomer(s), oligomer(s) and crosslinker(s) can contribute to lower discoloration rates. In certain embodiments, the composition includes at least one hydrophobic monomer having an alkyl group, especially a cycloalkyl group such as isobornyl or tricyclodecane functional group that will not form hydrogen bonding.

In certain embodiments, the crosslinker(s) and/or filler(s) provide discoloration resistance, improve strength, prevent crazing and/or increase wear resistance.

The antimicrobial agent prevents oral microorganisms growth on the denture surface, and reduces biofilm/denture plaques/tartar formation. The denture plaques compose micro-organisms that exist within an intercellular matrix consisting of organic and inorganic materials derived from saliva, gingival crevicular fluid and bacterial products. The plaque/tartar can easily build up from the food and beverages consume and because of the porous structure, it can absorb stains easily and change to yellow and even appear dingy gray or black too. As a result, the antimicrobial agent not only prevents oral inflammation but also slows down the staining rate.

The 3DP dentures provide discoloration resistance, improve strength (e.g., toughness), reduce bacteria growing on the denture surface, and/or increase wear resistance.

The components of the composition can be polymerized together via a 3D printing process.

In certain embodiments, the composite material inhibits growth and/or adhesion of common oral microorganisms, such as S. mutans and C. albicans. Antimicrobial composite materials used to form a substrate that contact the gums or palate of a patient when a dental appliance is fitted in the mouth of a patient material exhibit long-term activity against microbial colonizing units at body temperature (approximately 37° C.).

The polymerizable composition includes at least one oligomer. If the polymerizable composition included only monomers and no oligomers as initial reactants, then during the early stages of the polymerization of the composition as the molecular weight of the composition increases the viscosity undesirably increases, the solubility undesirably decreases and, in general, compatibility with other resins undesirably decreases. The presence of the oligomer(s) ameliorates these problems by decreasing the composition viscosity during polymerization of the composition. In addition, the oligomer(s) decreases the volatile organic compound content. Consequently, the resulting 3D-printed material has improved toughness and flexibility.

Illustrative oligomers include aliphatic urethane (meth)acrylate oligomers (e.g., CN 1970, CN 1966, CN 1963, CN 1967, CN 991, CN 996, and CN 9009 available from Sartomer; Exothane series, i.e., Exothane 8, Exothane 9, Exothane 10, Exothane 24, Exothane 26, Exothane 108, etc. available from ESS Tech Inc) and polyester acrylate oligomers (e.g., AR210Y30, N3D-13100, CN2295, CN2303, CN2264, etc. from Sartomer, and EBECRYL® 820, EBECRYL® 40, EBECRYL® 1871, etc. available from Allnex)

The polymerizable composition may comprise a total amount of polymerizable oligomer(s), in an amount of 1 wt % to 20 wt %, or 2 wt % to 20 wt %, or 5 wt % to 20 wt %, or 10 wt % to 20 wt % or 5 wt % to 15 wt %, or 10 wt % to 15 wt %, or 1 wt % to 10 wt %, or 2 wt % to 10 wt %, or 3 wt % to 10 wt %, or 4 wt % to 10 wt %, or 5 wt % to 10 wt % %, or 1 wt % to 5 wt %, or 2 wt % to 5 wt %, or 3 wt % to 5 wt %, based on the total weight of the polymerizable composition.

In certain embodiments, the polymerizable composition may comprise an aliphatic urethane (meth)acrylate oligomer, in an amount of 1 wt % to about 20 wt %, or about 2 wt % to 20 wt %, or 5 wt % to 20 wt %, or 10 wt % to 20 wt %, or 5 wt % to 15 wt %, or 10 wt % to 15 wt %, or 1 wt % to 10 wt %, or 2 wt % to 10 wt %, or 3 wt % to 10 wt %, or 4 wt % to 10 wt %, or 5 wt % to 10 wt %, or 1 wt % to 5 wt %, or 2 wt % to 5 wt %, 3 wt % to 5 wt %, based on the total weight of the polymerizable composition.

In certain embodiments, the polymerizable composition may comprise polyester acrylate oligomer, in an amount of 1 wt % to 20 wt %, or 5 wt % to 15 wt %, or 5 wt % to 10 wt %, based on the total weight of the polymerizable composition.

A polymerizable monomer suitable for use herein comprises one, two or more ethylenically unsaturated groups, and may comprise at least one polymerizable acrylic-based compound comprising a monoacrylate, diacrylate, polyacrylate, or methacrylate group. The composition may comprise at least one polymerizable acrylic compound, including, but not limited to, methyl acrylate (MA), methyl methacrylate (MMA), diurethanedimethacrylate (UDMA), diurethanedimethacrylate (DUDMA), bisphenol A-glycidylmethacrylate (BisGMA), isobornyl acrylate, isobornyl methacrylate, tricyclodecane dimethanol diacrylate (TDDDA), 2,2 bis[4-(methacryloxy ethoxy]phenyl]propane, tricyclodecane dimethanol dimethacrylate, 1,10-decanediol dimethacrylate, triethylene glycol dimethacrylate (TEGMA), 2-methacryloyloxyethyl phosphorylcholine (MPC), ethylene glycol dimethacrylate, diethylene glycol dimethacrylate, glycerol-dimethacrylate (GDMA) and 1,4-butanediol dimethacrylate, or a combination of one or more monomers, thereof.

In certain embodiments, the polymerizable composition comprises isobornyl acrylate and/or isobornyl methacrylate, and/or tricyclodecane dimethanol diacrylate (TDDDA).

The polymerizable composition may comprise a total amount of polymerizable monomer(s), in an amount of 10 wt % to 60 wt %, or 20 wt % to 60 wt %, or 30 wt % to 60 wt %, 40 wt % to 60 wt %, or about 10 wt % to 50 wt %, or 20 wt % to 50 wt %, 30 wt % to 50 wt % or about 10 wt % to 40 wt %, or 20 wt % to 40 wt %, or 30 wt % to 40 wt %, based on the total weight of the polymerizable composition.

In certain embodiments, the polymerizable composition may comprise isobornyl acrylate or tricyclodecane dimethanol diacrylate (TDDDA), in an amount of 10 wt % to 50 wt %, or about 20 wt % to 50 wt %, or 30 wt % to 50 wt %, or 40 wt % to 50 wt %, or 10 wt % to 40 wt %, or 20 wt % to 40 wt %, or 30 wt % to 40 wt %, based on the total weight of the polymerizable composition. The isobornyl acrylate or tricyclodecane dimethanol diacrylate may be a reactive diluent that provides faster UV curing.

The polymerizable composition also includes at least one crosslinker. The polymerizable composition also includes at least one crosslinker. The crosslinker increases the viscosity and molecular weight of polymeric matrix by forming covalent bonds and linking networks of multiple molecules. Illustrative crosslinkers include ethoxylated trimethylol propane trimethacrylate, trimethylolpropane trimethacrylate (TMPTMA), trimethylolpropane triacrylate (TMPTA), tris (2-hydroxyl ethyl) isocyanurate triacrylate (THEICTA) (e.g., SR368 available from Sartomer), ethoxylated (2) neopentylglycol diacrylate (EONPGDA), and triallyl isocyanurate (e.g., SR 533 from Sartomer).

The polymerizable composition may comprise a total amount of crosslinker(s) in an amount of 0.1 wt % to 15 wt %, or 1 wt % to 10 wt %, or 2 wt % to 10 wt %, or 3 wt % to 10 wt %, or 4 wt % to 10 wt %, or 5 wt % to 10 wt %, or 1 wt % to 5 wt %, or 2 wt % to 5 wt %, based on the total weight of the polymerizable composition.

The polymerizable composition includes at least one type, particularly at least two types, more particularly at least three types, of silanized glass filler particles. Illustrative silanized glass fillers include silanized ZrO silica glass, silanized barium borosilicate glass, and silanized barium-alumino-boro-silicate glass.

In certain embodiments, the silanized ZrO silica glass particles have a particle size of 0.01 μm to 0.5 μm, more particularly 0.1 μm to 0.3 μm.

In certain embodiments, the silanized barium borosilicate glass particles have a particle size of 0.1 μm to 10 μm, more particularly 1 μm to 3 μm.

In certain embodiments, the silanized barium-alumino-boro-silicate glass particles have a particle size of 0.01 μm to 5 μm, more particularly 0.1 μm to 1 μm.

The polymerizable composition may comprise a total amount of silanized glass filler(s) in an amount of 0.1 wt % to 10 wt %, or 1 wt % to 10 wt %, or 2 wt % to 10 wt %, or 3 wt % to 10 wt %, or 4 wt % to 10 wt %, or 5 wt % to 10 wt %, or 1 wt % to 5 wt %, or 2 wt % to 5 wt %, based on the total weight of the polymerizable composition.

In certain embodiments, the polymerizable composition may comprise ZrO silica glass in an amount of 0.1 wt % to 15 wt %, or 1 wt % to 15 wt %, or 2 wt % to 15 wt %, or 3 wt % to 15 wt %, or 4 wt % to 15 wt %, or 5 wt % to 15 wt %, or 6 wt % to 15 wt %, or 7 wt % to 15 wt %, or 8 wt % to 15 wt %, or 9 wt % to 15 wt %, or 1 wt % to 10 wt %, or 2 wt % to 10 wt %, or 3 wt % to 10 wt %, or 4 wt % to 10 wt %, 5 wt % to 10 wt %, or 6 wt % to 10 wt %, or 7 wt % to 10 wt %, based on the total weight of the polymerizable composition.

In certain embodiments, the polymerizable composition may comprise silanized barium borosilicate glass in an amount of 0.1 wt % to 10 wt %, or 1 wt % to 10 wt %, or 2 wt % to 10 wt %, or 3 wt % to 10 wt %, or 4 wt % to 10 wt %, or 5 wt % to 10 wt %, or 1 wt % to 5 wt %, or 2 wt % to 5 wt %, or 3 wt % to 5 wt %, or 1 wt % to 3 wt %, or 2 wt % to 3 wt %, based on the total weight of the polymerizable composition.

The polymerizable composition may also include fumed silica. The polymerizable composition may comprise fumed silica in an amount of 0.1 wt % to 10 wt %, or 1 wt % to 5 wt %, or 3 wt % to 3 wt %, based on the total weight of the polymerizable composition.

Photoinitiators described in the present disclosure can include those that can be activated with light and initiate polymerization of the polymerizable components of the formulation. A “photoinitiator”, as used herein, may generally refer to a compound that can produce radical species and/or promote radical reactions upon exposure to radiation (e.g., UV or visible light).

A composition that is light curable may comprise a photoinitiator system, such as camphorquinone (CQ), and ethyl 4-(dimethylamino)benzoate (EDMAB), TPO (monoacrylphosphine oxide), Ir819 (bisacrylphosphine oxide), 2,4,6-trimethylbenzoyldiphenylphosphine oxide, or methylbenzoin. The initiator may be present in an amount of at least 0.05 wt % to 5 wt %, or 1 wt % to 5 wt %, or 0.05 wt % to 2 wt %, or 0.1 wt % to 2 wt %, based on the weight of the polymerizable composite material.

A dental composite material provided herein comprises an antimicrobial particle component. In some embodiments, antimicrobial particles comprise silver, such as silver oxide, silver carbonate, silver zeolite, or zinc oxide, copper oxide or titanium oxide. Antimicrobial particles may include carbon-based, ceramic, metal, and polymeric nanoparticles acting as a substrate to an antimicrobial agent, such as silver or silver calcium phosphate. In one embodiment, antimicrobial particles comprise a silver-emitting ceramic, such as a silver sodium hydrogen zirconium phosphate (SSHZP) compound containing between 3 wt % and 10 wt % silver metal ion, based on the weight of the SSHZP compound (e.g., SSHZP sold under the trade name, SelectedSilver® Zr2K, by Milliken & Company).

Antimicrobial particles suitable for use herein include those having a high surface area to increase efficiency in reducing bacterial and fungal growth. Particles may have a size of approximately between 1 nm and 5 μm, or between 1 nm and 3 μm, or between 1 nm and 1 μm. Particle shapes suitable for use herein may be symmetrical or asymmetrical, such as spherical, diamond, octagonal, rhombohedral, non-spherical, or irregularly shaped particles, and the like. In some embodiments, the antimicrobial particle component may be present in an amount from 0.1 wt % to 10 wt %, 0.2 wt % to 10 wt %, 0.25 wt % to 10 wt %, 0.5 wt % to 10 wt %, 1 wt % to 10 wt %, 1.5 wt % to 10 wt %, 2 wt % to 10 wt %, 2.5 wt % to 10 wt %, 3 wt % to 10 wt %, 0.1 wt % to 6 wt %, 0.25 wt % to 6 wt %, 0.5 wt % to 6 wt %, 1 wt % to 6 wt %, 1.5 wt % to 6 wt %, 2 wt % to 6 wt %, 2.5 wt % to 6 wt %, 0.1 wt % to 4 wt %, 0.25 wt % to 4 wt %, 0.5 wt % to 4 wt %, 0.5 wt % to 4 wt %, 1 wt % to 4 wt %, 1.5 wt % to 4 wt %, and 2 wt % to 4 wt %, based on the total weight of the polymerizable composition. In some embodiments, an antimicrobial composition may comprise 3 wt % to 10 wt % of a zinc oxide, or 0.1 wt % to 10 wt % of silver, silver oxide or a combination thereof, based on the total weight of the antimicrobial polymerizable composition.

In addition to antimicrobial fillers, composite material may comprise other fillers known to enhance mechanical and esthetic properties in denture composite materials. Fillers may comprise an inorganic filler, an organic filler, or a combination thereof. Inorganic fillers may comprise silica, titanium dioxide, iron oxide, and silicon nitride, and a combination thereof. Glass fillers may comprise glass powder, including aluminum-based glass, borosilicate glass, strontium borosilicate, lithium silicate, lithium alumina silicate, silanized barium boron aluminosilicate, and silanized fluoride barium aluminosilicate, and a combination thereof. One or more fillers, including antimicrobial fillers may be added in an amount of up to 30 wt %, or 40 wt %, or 50 wt %, such as between 10 wt % and 30 wt %, based on the total weight of the polymerizable composition.

In certain embodiments, the polymerizable composition does not include poly(methyl/ethyl methacrylate), poly(methyl/butyl methacrylate), or a combination thereof.

The composition may comprise additional additives including stabilizers, opacifiers, colorants, and the like. The composition may comprise up to 5 wt % of an opacifier, such as zinc oxide, zirconium oxide, aluminum oxide, or titanium oxide, or a combination thereof. The composition may further comprise an inhibitor or a stabilizer such as butylated hydroxytoluene (BHT), hydroquinone (HQ), methyl ether of hydroquinone (MEHQ) or butylated hydroxyanisole (BHA) in an effective amount. In some embodiments, the inhibitor may be present in an amount of 0.05 wt % to 1 wt %, based on the weight of the polymerizable composition.

The polymerizable composition may be a one-part, light curable liquid system that is suitable for use in a three-dimensional (3D) printing system. For example, a homogenous mixture of all the formulation components may be formed. The components may be mixed using a spin-mixer to form homogenous mixtures. The homogenous mixtures may be suitable for use in 3D printing via a digital light process (DLP) method (such as using Asiga Pro or UV Max, MoonRAY Model S by SprintRay, and/or NextDent 5100, by 3D Systems). Test specimens were prepared by three-dimensional printing having dimensions required by test method protocols.

The sealant composition used in the methods disclosed herein may include the same ingredients as disclosed herein for the polymerizable 3D-printable composition.

In certain embodiments, the sealant composition includes a polyester acrylate oligomer. The polyester acrylate oligomer may be present in an amount of 0.1 wt % to 10 wt %, or 1 wt % to 10 wt %, or 2 wt % to 10 wt %, or 3 wt % to 10 wt % or 4 wt % to 10 wt %, or 5 wt % to 10 wt %, or 1 wt % to 5 wt %, or 2 wt % to 5 wt %, or 3 wt % to 5 wt %, based on the total weight of the sealant composition.

In certain embodiments, the sealant composition includes isobornyl acrylate. The isobornyl acrylate may be present in an amount of 1 wt % to 70 wt %, or 10 wt % to 70 wt %, or 20 wt % to 70 wt %, or 30 wt % to 70 wt %, or 40 wt % to 70 wt %, or 50 wt % to 70 wt %, or 10 wt % to 40 wt %, or 20 wt % to 40 wt %, or 30 wt % to 40 wt %, based on the total weight of the sealant composition.

In certain embodiments, the sealant composition does not include any silanized glass fillers.

In certain embodiments, a 3DP intraoral device produced from the polymerizable compositions disclosed herein has a stain resistance of less than 2.5, 2.0, or 1.5 AE (L*a*b* measurement) for one week soaked in black coffee. In certain embodiments, a 3DP intraoral device produced from the polymerizable compositions disclosed herein has a stain resistance of less than 4.5, 3.5, or 2.0 AE (L*a*b* measurement) for two weeks soaked in black coffee. In certain embodiments, a 3DP intraoral device produced from the polymerizable compositions disclosed herein has a stain resistance of less than 6.5, 6.0, or 4.5 AE (L*a*b* measurement) for three weeks soaked in black coffee. In certain embodiments, a 3DP intraoral device produced from the polymerizable compositions disclosed herein has a stain resistance of less than 5.0, 4.5, or 4.0 AE (L*a*b* measurement) for four weeks soaked in black coffee.

In certain embodiments, a 3DP intraoral device produced from the polymerizable compositions disclosed herein has a stain resistance of less than 2.0, 1.5, or 1.0 AE (L*a*b* measurement) for one week soaked in grape juice. In certain embodiments, a 3DP intraoral device produced from the polymerizable compositions disclosed herein has a stain resistance of less than 2.5, 2.0, or 1.5 AE (L*a*b* measurement) for two weeks soaked in grape juice. In certain embodiments, a 3DP intraoral device produced from the polymerizable compositions disclosed herein has a stain resistance of less than 3.5, 3.0, or 2.50 AE (L*a*b* measurement) for three weeks soaked in grape juice.

Several embodiments are described below in the following numbered clauses:

1. A method for making an intraoral device comprising:
mixing at least one oligomer, at least one hydrophobic monomer, at least one crosslinker, a first silanized glass filler having a particle size of 0.1 μm to 1 μm, a second silanized glass filler having a particle size of 0.1 μm to 6 μm, and at least one photoinitiator resulting in a mixture; and
polymerizing the resulting mixture in a mold to form the intraoral device.

2. The method of clause 1, wherein the oligomer is an aliphatic urethane (meth)acrylate oligomer.

3. The method of clause 1, wherein the oligomer is a polyester acrylate oligomer.

4. The method of clause 1, wherein the mixture comprises an aliphatic urethane (meth)acrylate oligomer and a polyester acrylate oligomer.

5. The method of clause 1, wherein the hydrophobic monomer is a cycloalkyl acrylate.

6. The method of clause 1, wherein the hydrophobic monomer is isobornyl acrylate.

7. The method of clause 1, wherein the silanized glass filler is silanized ZrO silica glass, silanized barium borosilicate glass, or silanized barium-alumino-boro-silicate glass.

8. The method of clause 1, wherein the mixture comprises silanized ZrO silica glass, silanized barium borosilicate glass, and silanized barium-alumino-boro-silicate glass.

9. The method of clause 1, wherein the mixture further comprises at least one antimicrobial agent.

10. The method of clause 9, wherein the antimicrobial agent is a silver sodium hydrogen zirconium phosphate compound.

11. The method of clause 1, wherein the crosslinker is trimethylolpropane trimethacrylate.

12. The method of clause 4, wherein the hydrophobic monomer is isobornyl acrylate, and the silanized glass filler is silanized ZrO silica glass, silanized barium borosilicate glass, or silanized barium-alumino-boro-silicate glass.

13. The method of clause 1, wherein the mixture comprises 5 wt % to 25 wt % oligomer, 40 wt % to 50 wt % hydrophobic monomer, 1 wt % to 10 wt % crosslinker, and 0.5 wt % to 25 wt % silanized glass filler, based on the total weight of the mixture.

14. The method of clause 6, wherein the mixture comprises 15 wt % to 30 wt % isobornyl acrylate, based on the total weight of the mixture.

15. The method of clause 5, wherein the mixture comprises silanized ZrO silica glass particles having a particle size of 0.1 μm to 0.5 μm, silanized barium-alumino-boro-silicate glass particles having a particle size of 0.1 μm to 1 μm, and silanized barium borosilicate glass particles having a particle size of 1 μm to 3 μm.

16. A method for making an intraoral device comprising:
mixing at least one oligomer, at least one monomer, at least one crosslinker, at least one silanized glass filler, and at least one photoinitiator resulting in a mixture;
forming the resulting mixture into an intraoral device shape using a three-dimensional printing method; and
light curing the mixture using the three-dimensional printing method to obtain the intraoral device.

17. The method of clause 16, wherein the oligomer is an aliphatic urethane (meth)acrylate oligomer.

18. The method of clause 16, wherein the oligomer is a polyester acrylate oligomer.

19. The method of clause 16, wherein the mixture comprises an aliphatic urethane (meth)acrylate oligomer and a polyester acrylate oligomer.

20. The method of clause 16, wherein the monomer is a cycloalkyl acrylate.

21. The method of clause 16, wherein the monomer is isobornyl acrylate.

22. The method of clause 16, wherein the silanized glass filler is silanized ZrO silica glass, silanized barium borosilicate glass, or silanized barium-alumino-boro-silicate glass.

23. The method of clause 16, wherein the mixture comprises silanized ZrO silica glass, silanized barium borosilicate glass, and silanized barium-alumino-boro-silicate glass.

24. The method of clause 16, wherein the mixture further comprises at least one antimicrobial agent.

25. The method of clause 24, wherein the antimicrobial agent is a silver sodium hydrogen zirconium phosphate compound.

26. The method of clause 16, wherein the crosslinker is trimethylolpropane trimethacrylate.

27. The method of clause 19, wherein the monomer is isobornyl acrylate, and the silanized glass filler is silanized ZrO silica glass, silanized barium borosilicate glass, or silanized barium-alumino-boro-silicate glass.

28. The method of clause 16, wherein the monomer is a hydrophobic monomer.

29. The method of clause 16, wherein the mixture comprises 1 wt % to 10 wt % oligomer, 45 wt % to 60 wt % monomer, 1 wt % to 10 wt % crosslinker, and 1 wt % to 25 wt % silanized glass filler, based on the total weight of the mixture.

30. The method of clause 21, wherein the mixture comprises 15 wt % to 30 wt % isobornyl acrylate, based on the total weight of the mixture.

31. The method of clause 16, wherein the mixture comprises a first silanized glass filler having a particle size of 0.1 μm to 1 μm, and a second silanized glass filler having a particle size of 0.1 μm to 6 μm.

32. The method of clause 20, wherein the mixture comprises silanized ZrO silica glass particles having a particle size of 0.1 μm to 0.5 μm, silanized barium-alumino-boro-silicate glass particles having a particle size of 0.1 μm to 1 μm, and silanized barium borosilicate glass particles having a particle size of 1 μm to 3 μm.

33. An intraoral device comprising a composite material that comprises: a polymeric matrix made from polymerizing at least one oligomer, at least one monomer, at least one crosslinker, and at least one photoinitiator; and at least one silanized glass filler.

34. An intraoral device made according to the method of clause 1.

35. An intraoral device made according to the method of clause 16.

36. The intraoral device of clause 34, wherein the device is a denture.

37. The intraoral device of clause 35, wherein the device is a denture.

38. The intraoral device of clause 34, wherein the device has a stain resistance of less than 2.5 AE (L*a*b* measurement) after one week soaked in black coffee, a stain resistance of less than 4.5 AE (L*a*b* measurement) after two weeks soaked in black coffee, a stain resistance of less than 6.5 AE (L*a*b* measurement) after three weeks soaked in black coffee, and a stain resistance of less than 5.0 AE (L*a*b* measurement) after four weeks soaked in black coffee.

39. The intraoral device of clause 38, wherein the device has a stain resistance of less than 2.5 AE (L*a*b* measurement) after one week soaked in black coffee, a stain resistance of less than 4.5 AE (L*a*b* measurement) after two weeks soaked in black coffee, a stain resistance of less than 6.5 AE (L*a*b* measurement) after three weeks soaked in black coffee, and a stain resistance of less than 5.0 AE (L*a*b* measurement) after four weeks soaked in black coffee.

40. The intraoral device of clause 34, wherein the device has a stain resistance of less than 2.0 AE (L*a*b* measurement) after one week soaked in grape juice, a stain resistance of less than 2.5 AE (L*a*b* measurement) after two weeks soaked in grape juice, and a stain resistance of less than 3.5 AE (L*a*b* measurement) after three weeks soaked in grape juice.

41. The intraoral device of clause 35, wherein the device has a stain resistance of less than 2.0 AE (L*a*b* measurement) after one week soaked in grape juice, a stain resistance of less than 2.5 AE (L*a*b* measurement) after two weeks soaked in grape juice, and a stain resistance of less than 3.5 AE (L*a*b* measurement) after three weeks soaked in grape juice.

42. A method comprising applying a sealant composition to at least a portion of a surface of the intraoral device of clause 34.

43. The method of clause 42, wherein the sealant composition comprises at least one oligomer, at least one monomer, at least one crosslinker, at least one silanized glass filler, and at least one photoinitiator.

### Examples

TABLE 1
Representative formulations (and concentration ranges)

| | Formula 1- | Formula 2 - | Formula 3 | Formula 4 |
|---|---|---|---|---|
| | denture Teeth | denture Base | (sealant 1) | (sealant 2) |
| Ingredients | % (range) | % (range) | % (range) | % (range) |
| Urethane | 45 (40-50) | 55 (45-60) | 30 (20-50) | 30 (20-50) |
| Dimethacrylate | | | | |
| (UDMA) | | | | |
| UDMA oligomer | 10 (5-15) | 5 (5-10) | 0 (0-3) | 0 (0-3) |
| Dimethacrylate | 5 (5-10) | 0 (0-5) | 5 (0-10) | 5 (0-10) |
| ester oligomer | | | | |
| Trimethylolpropane | 5 (1-10) | 5 (1-10) | 5 (1-10) | 5 (1-10) |
| trimethacrylate | | | | |
| Isobornyl acrylate | 25 (15 -30) | 20 (15-30) | 55 (20-70) | 55 (20-70) |
| MPC | 0 (0-10) | 0 (0-10) | 0 (0-10) | 5 (0-10) |
| Fume Silica | 2 (1-3) | 0 (0-3) | 1 (0-2) | 0 |
| Silver sodium | 1.5 (0.25-5a) | 1.5 (0.25-5) | 0.75 (0-5) | 0 |
| hydrogen | | | | |
| zirconium | | | | |
| phosphate (0.3 um) | | | | |
| Silaned ZrO silica | 3 (1-5) | 6 (1-8) | 0 (0-1) | 0 (0-1) |
| glass (<200 nm) | | | | |
| Silaned glass (0.4- | 3 (1-6) | 3 (1-6) | 0 (0-6) | 0 (0-6) |
| 0.7 um) | | | | |
| Silaned barium | 0.5 (0-2) | 1 (0-2) | 0 (0-1) | 0 (0-1) |
| borosilicate glass | | | | |
| (2 um) | | | | |
| Pigments | <0.1 | <0.1 | 0 | 0 |
| photoinitiator | 1 (0.1-5) | 1 (0.1-5) | 2 (0.1-5) | 2 (0.1-5) |

Oligomers and monomers were added to a clean, appropriately sized container in the order of from higher viscosity ingredient to lower viscosity ingredients, followed by adding UV blocker, inhibitor and initiator, respectively. In a separate container, a mixture of pigments was pre-mixed in a low viscosity monomer (example, TMPTMA) and then added into the base resins. After the mixtures were stirred under mechanical power mixer for over 6 hours to 12 hours to form homogenous monomer resin, the inorganic fillers were added in the order from smaller size to larger size by portions. The total mixtures were further stirred under mechanical power mixer for 6 to 12 hours. The final mixtures are ready for printing into denture devices.

Specimens for 3D denture base resin & 3D denture teeth (10 mm diameter×2 mm thickness) are designed with CAD software. The materials in Tables 2 and are prepared by filling ˜0.4 g resin in a 20 mm×1 mm mold, between two glass microscope slides-one on each side. Then UV light cured according to manufacturer's instructions, no further polishing is needed.

### Specimen Testing:

To detect color change, a spectrophotometer is used to provide more systematic, reliable and precise measurements. Spectrophotometers often report color by using CIELAB color system which represents the international standard for color measurement. It's well suited for the determination of small color differences. The American Dental Association (ADA) recommends the use of this system. In this system, any color is a combination of 3 spatial co-ordinates, which are designated as L*a*b*. L* represents the brightness of a shade and its value ranges from 0 (blackest) to 100 (whites). A* represents the amount of red-green color, value in positive (+) shift toward red region, value in negative (−) shift toward green region. b* represents the amount of yellow-blue color, value in positive (+) shift toward yellow region, value in negative (−) shift toward blue region. The CIELAB measurements evaluate the color of each specimen at a given time and they enable to calculate the amount of color change (ΔE) between two time interval by using formula: ΔE=(ΔL*2+Δα*2+Δb*2)^{1/2}.

The specimens were stored in black coffee (Kirkland 100% Columbian Coffee brand) at 37° C., refreshing the coffee every 24 hours without cleaning. The color evaluation for each specimen was measured after soaking in coffee every week up to 4 weeks. The amount of color change (ΔE) was calculated (Table 2 and Table 3).

The specimens were stored in grape juice (Welch's 100% Concord Grape Juice brand) at 37° C., refreshing the grape juice every 24 hours without cleaning. The color evaluation for each specimen was measured after soaking in grape juice every week up to 4 weeks. The amount of color change (ΔE) was calculated (Table 2 and Table 3).

In this study, assuming the mean time of drinking a cup of coffee or juice was 15 minutes and people often drink 3.2 cups of coffee or juice per day, one week storage in coffee or juice equates to seven months; two weeks storage in coffee or juice equates to fourteen months, while four weeks storage in coffee or juice equates to twenty-eight months in real life.

TABLE 2
ΔE (L*a*b* measurement) for commercial PMMA denture, commercial
3DP denture competitors and examples of the presently disclosed
3DP denture in the periods of 1 week to 4 weeks soaked in black
coffee and grape juice without professional cleaning.

| | | | | | grape | grape | Grape | Grape |
|---|---|---|---|---|---|---|---|---|
| | Coffee- | Coffee- | Coffee- | Coffee- | juice- | juice- | Juice- | Juice- |
| | 1 w | 2 w | 3 w | 4 w | 1 w | 2 w | 3 w | 4 w |
| | mean | mean | mean | mean | mean | mean | mean | mean |
| Product | ΔE | ΔE | ΔE | ΔE | ΔE | ΔE | ΔE | ΔE |
| GL3DP teeth- | 1.9 | 3.15 | 6.37 | 5.74 | 1.6 | 2.51 | 3.21 | 3.82 |
| A1 | | | | | | | | |
| GL3DP teeth- | 1.48 | 1.14 | 4.17 | 3.06 | 1.03 | 1.89 | 2.05 | 3.81 |
| A2 | | | | | | | | |
| GL3DP teeth- | 1.59 | 1.09 | 3.52 | 1.69 | 0.91 | 1.32 | 1.84 | 3.38 |
| A3 | | | | | | | | |
| GL3DP teeth- | 0.97 | 1.74 | 4.34 | 1.71 | 0.71 | 0.76 | 1.24 | 3.4 |
| C4 | | | | | | | | |
| Competitor | 6.96 | 10.42 | 12.42 | 9.34 | 1.7 | 3.79 | 3.63 | 2.93 |
| 3DP teeth-A1 | | | | | | | | |
| GL3DP Base- | 2.42 | 4.33 | 5.92 | 4.62 | 0.53 | 1.2 | 3.64 | 4.11 |
| G1 | | | | | | | | |
| 3DP Base | 5.65 | 7.1 | 7.37 | 5.08 | 2.67 | 4.08 | 3.54 | 3.29 |
| Competitor A- | | | | | | | | |
| pink | | | | | | | | |
| 3DP Base | 7.63 | 9 | 9.24 | 7.84 | 1.31 | 2.85 | 3.44 | 3.18 |
| Competitor B- | | | | | | | | |
| pink | | | | | | | | |
| PMMA | 1.61 | 2.56 | 4.74 | 4.24 | NA | NA | NA | NA |

TABLE 3
ΔE (L*a*b* measurement) for examples of the presently disclosed
3DP denture with or without applying sealant on the base-teeth interface
area for up to 20 days soaked in black coffee without cleaning.

| | GL3D- | GL3D | GL3D | GL3D |
|---|---|---|---|---|
| | Base | Base | teeth | Base |
| | wo/ | w/Sealant | w/Sealant | w/Sealant |
| Day # | Sealant | 2 | 1 | 1 |
| 1 | 0.84 | 0.53 | 0.53 | 0.74 |
| 2 | 1.22 | 0.69 | 0.83 | 0.84 |
| 3 | 1.36 | 0.67 | 0.78 | 0.65 |
| 4 | 1.49 | 0.72 | 0.82 | 0.72 |
| 5 | 1.88 | 0.76 | 0.82 | 0.61 |
| 6 | 2.03 | 1.17 | 0.97 | 0.58 |
| 7 | 2.11 | 0.85 | 1.01 | 0.71 |
| 8 | 2.47 | 1.18 | 1.11 | 0.49 |
| 9 | 2.46 | 1.02 | 0.98 | 0.77 |
| 10 | 2.54 | 1.19 | 0.96 | 0.74 |
| 11 | 2.74 | 1.36 | 1.13 | 0.73 |
| 12 | 2.94 | 1.07 | 1.19 | 0.78 |
| 13 | 3.06 | 1.05 | 1.31 | 0.78 |
| 14 | 3.17 | 1.34 | 1.41 | 0.87 |
| 20 | 4.33 | 1.4 | 1.46 | 0.81 |

The formulation for Sealant 1 and Sealant 2 is listed at Table 1, Formula 3 and Formula 4, respectively.

Oligomers and monomers were added to a clean, appropriately sized container in the order of from higher viscosity ingredient to lower viscosity ingredients, followed by adding UV blocker, inhibitor and initiator, respectively. The mixture was mechanically stirred for 4-6 hours until homogenous. The sealant was coated on specimens by brushing and post cured for 60 min at room temperature.

TABLE 4
Broad Spectrum Antimicrobial activities -in vitro (24 hours)

| | log | | log | | |
|---|---|---|---|---|---|
| | (CFU/ml) | | (CFU/ml) | | |
| organisms | control | StDev | Gl3D | StDev | Δlog |
| S. mutans | 7.70 | 0.17 | 0 | 0 | 7.7 |
| S. mitis | 5 | 0.36 | 0 | 0 | 5 |
| S. aureus | 6.37 | 0.17 | 2.6 | 1.84 | 3.77 |
| K. pneumoniae | 8.44 | 0.035 | 1.56 | 2.2 | 6.88 |
| C. albicans | 7.22 | 0.09 | 3.1 | 0.03 | 4.12 |
| C. galabrata | 6.52 | 0.11 | 1.7 | 0.1 | 4.82 |
| E. coli | 9.37 | 0.17 | 0 | 0 | 9.37 |

For antimicrobial activity assessment, denture specimens were quantitatively determined following American Standard Test Method (ASTM) E2180-07. The details of organisms, broth/media are listed on table 5. The example of the experimental procedure is: triplicate sterilized disks for control and treated denture (30 mm×30 mm×1 mm) were prepared for testing. S. mutans ATCC 25175 was cultured in Tryptic Soy Broth (TSB) and Tryptic Soy Agar, followed by incubation at 35±2° C. with 5% CO2 for 18±2 hours. C. albicans ATCC 14053 was cultured in Sabouraud Dextrose Broth and Emmon's Sabouraud Dextrose Agar, then incubated at 37±2° C. for 18 hours. Each disk was covered with 1.0 ml of agar slurry, which contained approximately 1.5×10⁶ CFU/ml of S. mutans and C. albicans. After 24 hours incubation, the disks and agar were put into 10 ml of Dey-Engley (D/E) Neutralizing Broth and vortexed to release agar inoculum. Serial dilutions were performed in D/E Neutralizing Broth, and 1 ml of solution was spread onto plates and incubated for 48±2 hours. Viable colonies (CFU) were counted and transformed to logarithmic counts.

| Organisms | ATCC # | Broth used | Media used | manufacturers |
|---|---|---|---|---|
| S. mutans | ATCC | Todd-Hewitt | Tryptic Soy Agar | Hardy Diagnostics |
| | 25175 | broth | | |
| S. mitis | NCIMB | Todd-Hewitt | Tryptic Soy Agar | Hardy Diagnostics |
| | 13770 | broth | | |
| S. aureus | ATCC | Tryptic Soy | Tryptic Soy Agar | Hardy Diagnostics |
| | 6538P | Broth | | |
| K. pneumoniae | ATCC | Tryptic Soy | Tryptic Soy Agar | Hardy Diagnostics |
| | 700603 | Broth | | |
| E. coli | ATCC | Tryptic Soy | Tryptic Soy Agar | Hardy Diagnostics |
| | 8739 | Broth | | |
| C. albicans | ATCC | Sabdex Broth | Sabdex (Sabouraud | Hardy Diagnostics |
| | 14053 | | Dextrose) Agar | |
| C. galabrata | ATCC | Sabdex Broth | Sabdex (Sabouraud | Hardy Diagnostics |
| | 15126 | | Dextrose) Agar | |

In view of the many possible embodiments to which the principles of the disclosed invention may be applied, it should be recognized that the illustrated embodiments are only preferred examples of the invention and should not be taken as limiting the scope of the invention.

What is claimed is:

1. A method for making an intraoral device comprising:
mixing at least one oligomer, at least one monomer, at least one crosslinker, at least one silanized glass filler, and at least one photoinitiator resulting in a mixture;
forming the resulting mixture into an intraoral device shape using a three-dimensional printing method; and
light curing the mixture using the three-dimensional printing method to obtain the intraoral device.

2. The method of claim 1, wherein the mixture comprises an aliphatic urethane (meth)acrylate oligomer, or a polyester acrylate oligomer, or an aliphatic urethane (meth)acrylate oligomer and a polyester acrylate oligomer.

3. The method of claim 1, wherein the monomer is a cycloalkyl acrylate.

4. The method of claim 1, wherein the monomer is isobornyl acrylate.

5. The method of claim 1, wherein the mixture comprises silanized ZrO silica glass, silanized barium borosilicate glass, and silanized barium-alumino-boro-silicate glass.

6. The method of claim 1, wherein the crosslinker is trimethylolpropane trimethacrylate.

7. The method of claim 4, wherein silanized glass filler is silanized ZrO silica glass, silanized barium borosilicate glass, or silanized barium-alumino-boro-silicate glass.

8. The method of claim 1, wherein the monomer is a hydrophobic monomer.

9. The method of claim 1, wherein the mixture comprises 1 wt % to 10 wt % oligomer, 45 wt % to 60 wt % monomer, 1 wt % to 10 wt % crosslinker, and 1 wt % to 25 wt % silanized glass filler, based on the total weight of the mixture.

10. The method of claim 4, wherein the mixture comprises 15 wt % to 30 wt % isobornyl acrylate, based on the total weight of the mixture.

11. The method of claim 1, wherein the mixture comprises silanized ZrO silica glass particles having a particle size of 0.1 μm to 0.5 μm, silanized barium-alumino-boro-silicate glass particles having a particle size of 0.1 μm to 1 μm, and silanized barium borosilicate glass particles having a particle size of 1 μm to 3 μm.

12. A method for making an intraoral device comprising:
mixing at least one oligomer, at least one hydrophobic monomer, at least one crosslinker, a first silanized glass filler having a particle size of 0.1 μm to 1 μm, a second silanized glass filler having a particle size of 0.1 μm to 6 μm, and at least one photoinitiator resulting in a mixture; and
polymerizing the resulting mixture in a mold to form the intraoral device.

13. The method of claim 12, wherein the mixture comprises an aliphatic urethane (meth)acrylate oligomer, a polyester acrylate oligomer, or an aliphatic urethane (meth)acrylate oligomer and a polyester acrylate oligomer.

14. The method of claim 12, wherein the hydrophobic monomer is a cycloalkyl acrylate.

15. The method of claim 12, wherein the mixture comprises silanized ZrO silica glass, silanized barium borosilicate glass, and silanized barium-alumino-boro-silicate glass.

16. The method of claim 14, wherein the mixture comprises silanized ZrO silica glass particles having a particle size of 0.1 μm to 0.5 μm, silanized barium-alumino-boro-silicate glass particles having a particle size of 0.1 μm to 1 μm, and silanized barium borosilicate glass particles having a particle size of 1 μm to 3 μm.

17. An intraoral device made according to the method of claim 12.

18. The intraoral device of claim 17, wherein the device has a stain resistance of less than 2.5 AE (L*a*b* measurement) after one week soaked in black coffee, a stain resistance of less than 4.5 AE (L*a*b* measurement) after two weeks soaked in black coffee, a stain resistance of less than 6.5 AE (L*a*b* measurement) after three weeks soaked in black coffee, and a stain resistance of less than 5.0 AE (L*a*b* measurement) after four weeks soaked in black coffee.

19. The intraoral device of claim 17, wherein the device has a stain resistance of less than 2.0 AE (L*a*b* measurement) after one week soaked in grape juice, a stain resistance of less than 2.5 AE (L*a*b* measurement) after two weeks soaked in grape juice, and a stain resistance of less than 3.5 AE (L*a*b* measurement) after three weeks soaked in grape juice.

20. A method comprising applying a sealant composition to at least a portion of a surface of the intraoral device of claim 17, and the sealant composition comprises at least one oligomer, at least one monomer, at least one crosslinker, at least one silanized glass filler, and at least one photoinitiator.
